(19) United States
(12) Patent Application Publication
(10) Pub. No.: US 2015/0142417 A1
(43) Pub. Date: May 21, 2015

(54) TRANSLATION DEVICE AND CONTROL METHOD THEREOF

(71) Applicants: INVENTEC CORPORATION, Taipei City (TW); INVENTEC (PUDONG) TECHNOLOGY CORPORATION, Shanghai (CN)

(72) Inventor: HSUEH-LIANG CHEN, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 14/227,918

(22) Filed: Mar. 27, 2014

(30) Foreign Application Priority Data
Nov. 21, 2013 (CN) 201310595160.0

(51) Int. Cl. G06F 17/28

(52) U.S. Cl. CPC G06F 17/289
USPC 704/3

(57) ABSTRACT

A translation device and a control method thereof are provided, where the translation device includes an image capturing module, an eye tracing module, a processing module, and a prompt module. The processing module electrically connects to the image capturing module, the eye tracing module, and the prompt module. The image capturing module acquires an external image. The eye tracing module traces a gazing area of an eye of a user and according to states of the eye, generates a triggering signal. When receiving the triggering signal, the processing module superimposes the gazing area and the external image, and translates a text, which the gazing area focuses on, in the external image from a first language to a second language. The prompt module generates a prompt signal carrying the translation result of the second language.

### CROSS-REFERENCE TO RELATED APPLICATIONS

This non-provisional application claims priority under 35 U.S.C. §119(a) on Patent Application No(s). 201310595160.0 filed in China on Nov. 21, 2013, the entire contents of which are hereby incorporated by reference.

### BACKGROUND OF THE INVENTION

1. Technical Field of the Invention

The disclosure relates to a translation device and a control method thereof, and more particularly to a translation device and a control method thereof which are capable of translating texts or sounds in real time.

2. Description of the Related Art

Nowadays, translation devices can mainly be classified as translators with an input module (e.g. physical buttons or a touch panel) or as pen translators capable of directly scanning desired texts (i.e. pen scanner-and-translators).

However, both of the translator and the pen translator require users to use their hand to input desired information under translation. The translator requires users to input desired information via, e.g. a keyboard. The pen translator requires users to aim the pen translator at the location of desired information, so as to scan it. When a user operates such a pen translator, information available to be translated is limited by the scanning region where the user's hand or the pen translator can arrive. In other words, when the user wants to translate information whose location is outside the scanning region where the user's hand or the pen translator can arrive, the user has to move the pen translator until the pen translator can arrive and be aimed at the location of desired information. Because not every location of desired information under translation can be arrived by the user's hand or the pen translator, the range of information available to be translated will be limited.

Therefore, when users use hands to input desired information into the translator or use the pen translator to manually scan desired information, the speed of translation would be slowed down.

### SUMMARY OF THE INVENTION

According to an embodiment of the disclosure, a translation device adapted to be put on the head of a user includes an image capturing module configured to capture an external image; an eye tracing module configured to trace a gazing area of an eye of the user and according to states of the eye, generate a triggering signal; a processing module electrically connecting to the image capturing module and the eye tracing module and being configured to, when receiving the triggering signal, superimpose the gazing area of the external image, and then translate a text, which the gazing area focuses on, in the external image from a first language to a second language; and a prompt module, electrically connecting to the processing module and being configured to generate a prompt signal carrying the translation result of the second language.

In an embodiment of the translation device, the above prompt module is a display module on which the prompt signal is shown as images presenting a text of the second language.

In this embodiment, the translation device is a glasses structure, and the display module is lenses of the glasses structure.

In this embodiment, the translation device further includes a connection structure via which the translation device is fixed on a frame of a glasses structure, whereby the display module correspond to lenses of the glasses structure.

In an embodiment of the translation device, the above prompt module is a sound playing module through which a text of the second language carried by the prompt signal is played.

In an embodiment of the translation device, the translation device further includes a sound receiving module electrically connecting to the processing module and being configured to capture sounds of the first language. The processing module further translates the sounds of the first language into sounds of the second language.

In this embodiment, the translation device further includes a first switch module electrically connecting with the processing module, the image capturing module, the eye tracing module, and the sound receiving module, and being configured to selectively enable a path between the processing module and the image capturing module and a path between the processing module and the eye tracing module or enable a path between the processing module and the sound receiving module.

In an embodiment of the translation device, the translation device further includes a second switch module electrically connecting with the processing module and the prompt module and being configured to control the prompt module to present the prompt signal by images or sounds.

In an embodiment of the translation device, the translation device further includes a storage module electrically connecting to the processing module and being configured to store text files and audio files of the first language and the second language.

According to an embodiment of the disclosure, a control method for a translation device includes steps of: acquiring an external image; tracing a gazing area of an eye, and generating a triggering signal according to states of the eye; superimposing the traced gazing area and the external image, and translating a text, which the gazing area focuses on, in the external image from a first language to a second language; and generating a prompt signal carrying the translation result of the second language.

In an embodiment of the control method, a text of the second language carried by the prompt signal is displayed by images.

In an embodiment of the control method, a text of the second language carried by the prompt signal is played by sounds.

In an embodiment of the control method, the control method further includes a step of receiving sounds of the first language, and translating the sounds of the first language into the second language.

In an embodiment of the control method, the control method further includes a step of setting the prompt signal to be presented as images or sounds.

### BRIEF DESCRIPTION OF THE DRAWINGS

The present disclosure will become more fully understood from the detailed description given herein below for illustration only and thus does not limit the present disclosure, wherein:

FIG. 1 is a block diagram of a translation device according to an embodiment of the disclosure;

FIG. 2 is a block diagram of a translation device according to another embodiment of the disclosure; and

FIG. 3 is a flowchart of a control method of a translation device according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### One Embodiment of a Translation Device

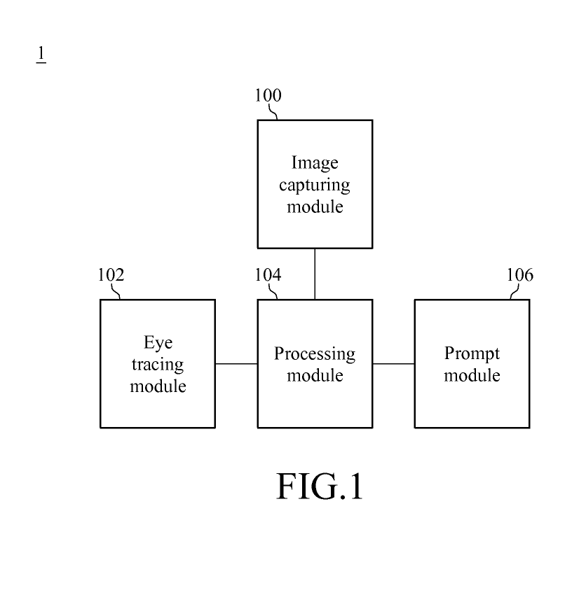

FIG. 1 is a block diagram of a translation device 1 according to an embodiment of the disclosure. The translation device 1 is adapted to be put on a user's head and mainly includes an image capturing module 100, an eye tracing module 102, a processing module 104, and a prompt module 106. The processing module 104 electrically connects to the image capturing module 100, the eye tracing module 102, and the prompt module 106. The detail of each module in the translation device 1 is described below.

The image capturing module 100 captures external images ambient to the user. Specifically, the image capturing module 100 can automatically capture the ambient environment around the user to generate external images after focusing on the ambient environment. In an exemplary embodiment but not by way of limitation, the image capturing module 100 can be a lens with a charge coupled device (CCD) or a complementary metal oxide semiconductor (CMOS) capable of sensing images.

The eye tracing module 102 traces a gazing area of the user's eye, and generates a set of triggering signals according to states of the eye. Specifically, the eye tracing module 102 can detect and trace the direction, angle, and region that the user's eye focuses on. When states of the user's eye obtained by the eye tracing module 102 match a set of preset triggering conditions, the eye tracing module 102 will generate the triggering signals. In an example but not by way of limitation, the preset triggering conditions may be a preset number of times of blinking (e.g. twice), a preset period of gazing (e.g. the line of sight stays at the same gazing area for more than two seconds), or any possible parameters which are set according to particular requirements. In a particular embodiment but not by way of limitation, the eye tracing module 102 can be lenses with a CCD or a CMOS or other possible eye trackers, which can detect the change of pupils and lenses of eyes.

The processing module 104 superimposes the gazing area obtained by the eye tracing module 102 and the external image obtained by the image capturing module 100 and translates a text of first language in the external image, which corresponds to the gazing area, into a second language when receiving the triggering signals. In other words, the processing module 104 first performs a comparison process on the gazing area and the external image to know what the user focuses on, and then translates the text in the gazing area from the first language to the second language. In an example but not by way of limitation, the processing module 104 can be a microcontroller or a central processing unit (CPU). In an example but not by way of limitation, the first language and the second language can be any possible different languages.

The prompt module 106 generates a set of prompt signals according to the translation result of the processing module 104. The translation result carried by prompt signal is presented in the second language by images (i.e. words) or sounds. In a particular embodiment but not by way of limitation, the prompt module 106 can be a display module or a sound playing module (e.g. a speaker). As a display module, the prompt module 106 displays the prompt signal by images showing the texts of the second language. As a sound playing module, the prompt module 106 plays the prompt signal by sounds presenting the texts of the second language.

As an example but not by way of limitation, the display module can be an organic light emitting diode (OLED) displayer, an active matrix organic light emitting diode (AMOLED) displayer, a thin film transistor liquid crystal displayer (TFT-LCD) or a transmission type displayer with a transparent structure. The type, side or location of the display module can be defined according particular requirements.

In the case of the transmission type displayer, even though the transmission type displayer is disposed in front of the user's eyes, the user can still see the front scenes through the transmission type displayer. Take a transmission type displayer formed by a transparent liquid crystal screen as an example. The transparent liquid crystal screen has at least one white LED at four sides of its frame. These white LEDs' provide part of the backlight for the transparent liquid crystal screen, and the reset of backlight of the transparent liquid crystal screen is provided by the ambient light of the transparent liquid crystal screen. Thereby, users can see visual information through the transparent liquid crystal screen. This can reduce the power consumption of the display module and increase the lifespan of the translation device 1. Moreover, while watching texts shown by the transparent liquid crystal screen, i.e. the display module, users can sense the change of environment in real time.

In addition, the imaging method of the display module can be defined according to particular requirements. The imaging method can be real images shown on the display module or be virtual images shown outside the display module. As another example, the display module can be a projection displayer having a projection function, which projects images on a screen or the user's retina.

On the other hand, because the translation device 1 is adapted to be put on the user's head and a transmission type displayer is taken as an example of the prompt module 106, the translation device 1 can be considered as a glasses structure where the prompt module 106 can be at least one lens of the glasses structure. The image capturing module 100 and the eye tracing module 102 can be disposed on the frame of the glasses structure and respectively correspond to the ambient environment and eyes of the user. Moreover, the translation device 1 can further include a connection structure, such as a magnetic structure or a buckling structure, via which the translation device 1 can be fixed on the frame of the glasses structure, so that the prompt module 106 can correspond to the lenses of the glasses structure.

In this case, the display module can further be disposed with a photochromic film which can automatically change its color according to the intensity of ultraviolet (UV) light, so as to protect the user's eyes from tiredness and discomfort caused by the glare. This photochromic film can be formed on the display module by, for example, hot melting or coating.

### Another Embodiment of a Translation Device

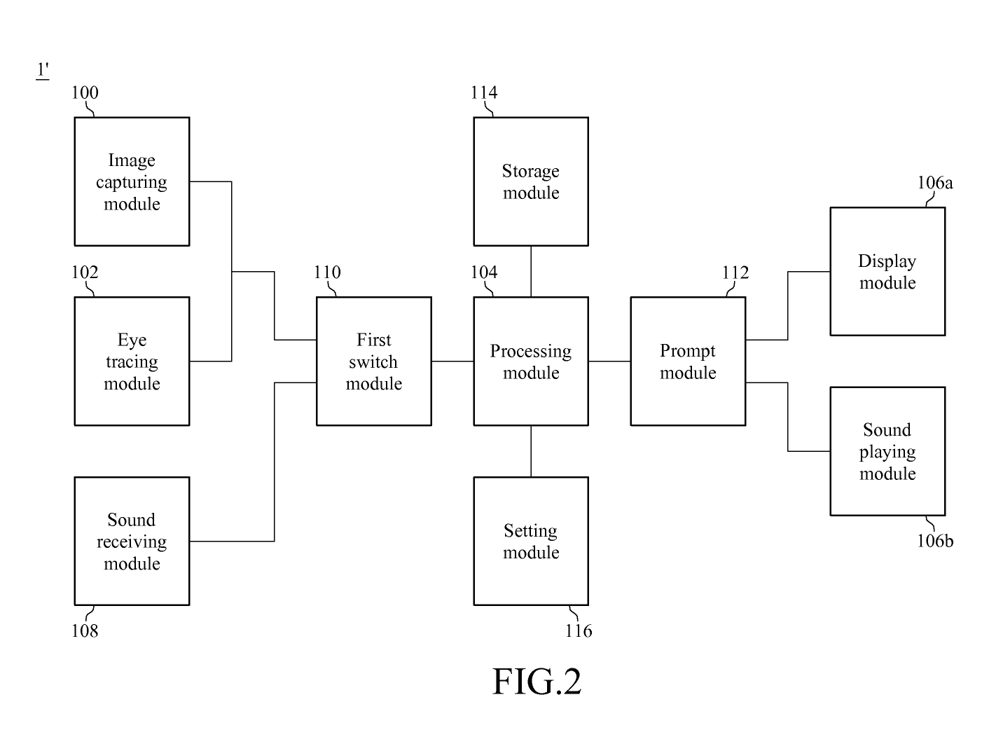

FIG. 2 is a block diagram of a translation device 1′ according to another embodiment of the disclosure. The translation device 1′ is adapted to be put on a user's head and mainly includes an image capturing module 100, an eye tracing module 102, a processing module 104, a display module 106a, a sound playing module 106b, a sound receiving module 108, a first switch module 110, a second switch module 112, a storage module 114, and a setting module 116. The processing module 104 electrically connects to the first switch module 110, the second switch module 112, the storage module 114, and the setting module 116.

The first switch module 110 also electrically connects to the image capturing module 100, the eye tracing module 102, and the sound receiving module 108. The second switch module 112 also electrically connects to the display module 106a and the sound playing module 106b.

The operation and connections of most of the modules in the translation device 1′ are the same as those of the modules in the translation device 1 and thus not described again hereinafter. However, the translation device 1′ further includes the display module 106a and the sound playing module 106b to output the translation by the display module 106a, the sound playing module 106b, or both via the second switch module 112.

The sound receiving module 108 captures sounds of a first language, and then the processing module 104 translates the sounds from the first language to a second language. For example, the sound receiving module 108 can be a microphone or a jack for a microphone.

The first switch module 110 selectively enables the path between the image capturing module 100 and the processing module 104 and the path between the eye tracing module 102 and the processing module 104 or enables the path between the sound receiving module 108 and the processing module 104, so as to provide the user with different options for receiving information under translation.

The storage module 114 stores text files and audio files of the first language and the second language whereby the processing module 104 can perform the translation process through the text files and audio files. In a particular embodiment but not by way of limitation, the storage module 114 can be a non-volatile memory such a programmable read-only memory (PROM), an erasable programmable read-only memory (EPROM), an electrically erasable programmable read-only memory (EEPROM) or a flash memory, or a volatile memory such as a dynamic random access memory (DRAM) or a static random access memory (SRAM).

The setting module 116 provides the user with parameters for manually setting the translation device 1′, such as the setting of the language of translation result, the setting of the method for receiving information under translation, and the setting of output method of the translation result. In a particular embodiment but not by way of limitation, the setting module 116 can be function keys similar to buttons or be a function control interface, which has, for example, checking, canceling, selection, and any suitable functions. Moreover, the setting module 116 can be disposed in the display module 106a, so as to form a touch displayer through which users can control the translation device 1′ by touching the display module 106a.

### One Embodiment of a Control Method of a Translation Device

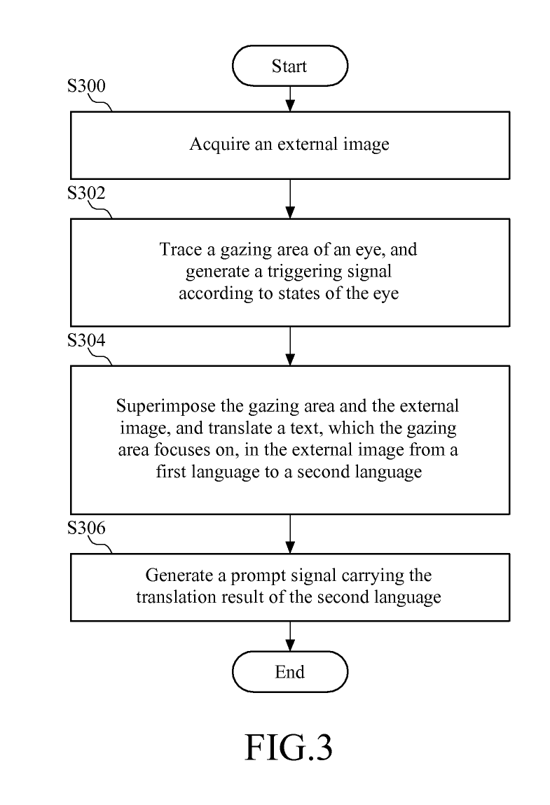

FIG. 3 is a flowchart of a control method of a translation device according to an embodiment of the disclosure. The control method is adapted to the translation device 1 in FIG. 1 which can be put on the user's head.

The image capturing module 100 in the translation device 1 acquires an external image (S300), and the eye tracing module 102 in the translation device 1 traces a gazing area of the user's eyes and according to states of the eyes, generates a set of triggering signals (S302). Then, the processing module 104 in the translation device 1 superimposes the gazing area and the external image and translates a text, which the gazing area focuses on, in the external image from a first language to a second language (S304). Finally, the prompt module 106 in the translation device 1 generates a set of prompt signals carrying the translation result of the second language (S306).

As set forth the above, the disclosure, providing a translation device and a control method thereof, acquires an external image, traces a gazing area of a user's eye, superimposes the external image and the gazing area to know which text the user want to translate, and outputs the translation result by an image type, a sound type, or both of them. Moreover, the translation device can be used as a glasses structure with a transmission type displayer. Through the disclosure, it is not necessary for users to use hands to input desired information under translation, and information available to be translated is not limited by the scanning region where the user's hand or the pen translator can arrive. Thus, the disclosure can translate texts or sounds from a language to another language in real time.

What is claimed is:

1. A translation device, adapted to be put on the head of a user and comprising:
an image capturing module, configured to capture an external image;
an eye tracing module, configured to trace a gazing area of an eye of the user and according to states of the eye, generate a triggering signal;
a processing module, electrically connecting to the image capturing module and the eye tracing module and being configured to, when receiving the triggering signal, superimpose the gazing area and the external image and translate a text, which the gazing area focuses on, in the external image from a first language to a second language; and
a prompt module, electrically connecting to the processing module and being configured to generate a prompt signal carrying the translation result of the second language.

2. The translation device according to claim 1, wherein the prompt module is a display module on which the prompt signal is shown as images presenting a text of the second language.

3. The translation device according to claim 2, wherein the translation device is a glasses structure, and the display module is lenses of the glasses structure.

4. The translation device according to claim 2, further comprising a connection structure via which the translation device is fixed on a frame of a glasses structure, whereby the display module correspond to lenses of the glasses structure.

5. The translation device according to claim 1, wherein the prompt module is a sound playing module through which a text of the second language carried by the prompt signal is played.

6. The translation device according to claim 1, further comprising a sound receiving module, electrically connecting to the processing module and being configured to capture sounds of the first language, wherein the processing module further translates the sounds of the first language into sounds of the second language.

7. The translation device according to claim 6, further comprising: a first switch module electrically connecting with the processing module, the image capturing module, the eye tracing module, and the sound receiving module, and being configured to selectively enable a path between the processing module and the image capturing module and a path between the processing module and the eye tracing module or enable a path between the processing module and the sound receiving module.

8. The translation device according to claim 1, further comprising: a second switch module, electrically connecting with the processing module and the prompt module and being configured to control the prompt module to present the prompt signal by images or sounds.

9. The translation device according to claim 1, further comprising: a storage module electrically connecting to the processing module and being configured to store text files and audio files of the first language and the second language.

10. A control method for a translation device, comprising:
acquiring an external image;
tracing a gazing area of an eye, and generating a triggering signal according to states of the eye;
superimposing the traced gazing area and the external image, and translating a text, which the gazing area focuses on, in the external image from a first language to a second language; and
generating a prompt signal carrying the translation result of the second language.

11. The control method according to claim 10, wherein a text of the second language carried by the prompt signal is displayed by images.

12. The control method according to claim 10, wherein a text of the second language carried by the prompt signal is played by sounds.

13. The control method according to claim 10, further comprising: receiving sounds of the first language, and translating the sounds of the first language into the second language.

14. The control method according to claim 10, further comprising: setting the prompt signal to be presented as images or sounds.
